(19) United States
(12) Patent Application Publication
(10) Pub. No.: US 2014/0298050 A1
(43) Pub. Date: Oct. 2, 2014

(54) INFORMATION PROCESSING APPARATUS, CONTROL METHOD AND COMPUTER-READABLE RECORDING MEDIUM

(71) Applicant: Tatsuya Nagase, Kanagawa (JP)

(72) Inventor: Tatsuya Nagase, Kanagawa (JP)

(21) Appl. No.: 14/354,733

(22) PCT Filed: Nov. 30, 2012
(86) PCT No.: PCT/JP2012/081714

§ 371 Date: Apr. 28, 2014

(30) Foreign Application Priority Data
Dec. 2, 2011 (JP) 2011-265009

(51) Int. Cl. G06F 9/44; G06F 1/26

(52) U.S. Cl. CPC G06F 9/44; G06F 1/26
USPC 713/300; 718/100

(57) ABSTRACT

An information processing apparatus includes a hardware button configured to enable a user to press; a control unit configured to define a predetermined press process executed in response to a press of the hardware button; a processing unit configured to execute a predetermined process; a press detection unit configured to detect the press of the hardware button; a press process rejection unit configured to instruct the control unit to reject the execution of the press process when the press of the hardware button is detected; and a process execution unit configured to instruct the processing unit to execute the predetermined process when the press of the hardware button is detected.

### TECHNICAL FIELD

The present invention relates to an information processing apparatus, a control method and a computer-readable recording medium.

### BACKGROUND ART

A conference system has become popular in which a remote conference with a remote place is conducted via a communication network such as the Internet. According to such a conference system, in a conference room in which one interested party such as an attendee to conduct a remote conference is present, images in the conference room such as images of the interested parties of the conference are taken using a terminal apparatus of the remote conference system, sound such as remark is collected, and these taken images and sound are converted into digital data and transmitted to a terminal apparatus of the other party. Subsequently, in this conference system, the taken images are displayed in a display apparatus in a conference room of the other party and the sound is output by a speaker such that the conference close to an actual conference is conducted between remote places.

However, in a case where a device mounting existing Windows (registered trademark) as an operating system (OS) is used as a terminal apparatus, it differs from a terminal apparatus produced by the firm in operations at the time a specific hardware button is pressed.

For example, in the case of an example where the hardware button is a power button, even if the power button of the terminal apparatus produced by the firm is pressed, the power is not turned off. Further, to press the power button is recognized as a keyboard input of a personal computer (PC) and is therefore a trigger to execute a specific process by software.

However, the power button of the terminal apparatus mounting Windows (registered trademark) as an OS is recognized as the power button of the PC. As a result, when the power button is pressed, the power is turned off, and thus there is a problem that, when it is pressed, it is not possible to execute other operations and processes.

Here, in order to avoid directly turning off the power by mistake without shutdown by software regardless of the state that the software normally operates when the power button is pressed, Japanese Patent Application Laid-open No. 2010-049590 discloses a technique of: setting a software report unit to report whether software normally operates, in a control apparatus; and, based on the state of a signal output from this software report unit, selecting whether to directly turn off the power or execute the shutdown by software.

Also, in order to avoid that it is not possible to transmit and receive image data and sound data due to an occurrence of failure in a relay apparatus and relay server in a case where the load on the relay apparatus and the relay server is over an acceptable load amount in a teleconference system, Japanese Patent Application Laid-open No. 2011-199845 discloses a technique of: relaying basic data essential for a playback of images and sound by a basic data relay system including a plurality of basic data relay units and a selection unit that selects one basic data relay unit every communication with a transmission terminal from these basic data relay apparatuses; and relaying extension data to enhance quality of these images and sound by an extension data relay apparatus.

However, even with the conventional technologies, there is a problem that, when a specific hardware button is pressed, it is not possible to execute another process without executing a process corresponding to the hardware button. For example, even when the power button is pressed, it is not possible to execute another process without executing a power-off process, which is inconvenient for the user.

Therefore, there is a need for an information processing apparatus, a control method and a computer-readable recording medium that can execute, even when a specific hardware button is pressed, another process without executing a process corresponding to the hardware button, which is convenient for the user.

### DISCLOSURE OF INVENTION

It is an object of the present invention to at least partially solve the problems in the conventional technology.

According to an embodiment, there is provided an information processing apparatus that includes a hardware button configured to enable a user to press; a control unit configured to define a predetermined press process executed in response to a press of the hardware button; a processing unit configured to execute a predetermined process; a press detection unit configured to detect the press of the hardware button; a press process rejection unit configured to instruct the control unit to reject the execution of the press process when the press of the hardware button is detected; and a process execution unit configured to instruct the processing unit to execute the predetermined process when the press of the hardware button is detected.

According to another embodiment, there is provided a control method executed in an information processing apparatus including a hardware button configured to enable a user to press. The method includes executing a predetermined process by a processing unit; detecting the press of the hardware button by a press detection unit; instructing, by a press process rejection unit, a control unit to reject the execution of a predetermined press process when the press of the hardware button is detected, the control unit defining the press process executed in response to a press of the hardware button; and instructing, by a process execution unit, the processing unit to execute the predetermined process when the press of the hardware button is detected.

According to still another embodiment, there is provided a computer-readable recording medium with an executable program stored thereon. The program instructs a computer that includes a hardware button configured to enable a user to press, to perform: executing a predetermined process; detecting the press of the hardware button; instructing a control unit to reject the execution of a predetermined press process when the press of the hardware button is detected, the control unit defining the press process executed in response to a press of the hardware button; and instructing the execution of the predetermined process when the press of the hardware button is detected.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a hardware, configuration view of an information processing apparatus according to a first embodiment;

FIG. 2 is a block diagram illustrating a functional configuration of an information processing apparatus according to the first embodiment;

FIG. 3 is a flowchart illustrating the steps of a control process according to the first embodiment;

FIG. 4 is a view illustrating a flow of events between units in the control process according to the first embodiment;

FIG. 5 is a view illustrating an example of a power-off inquiry dialogue box;

FIG. 6 is a block diagram illustrating a functional configuration of an information processing apparatus according to a second embodiment;

FIG. 7 is a view illustrating an example of control information;

FIG. 8 is a view illustrating an example of a process table; and

FIG. 9 is a flowchart illustrating the steps of a control process in the second embodiment.

### BEST MODES FOR CARRYING OUT THE INVENTION

With reference to the accompanying drawings, embodiments of an information processing apparatus, control method and a computer-readable recording medium according to the present invention will be explained in detail.

### First Embodiment

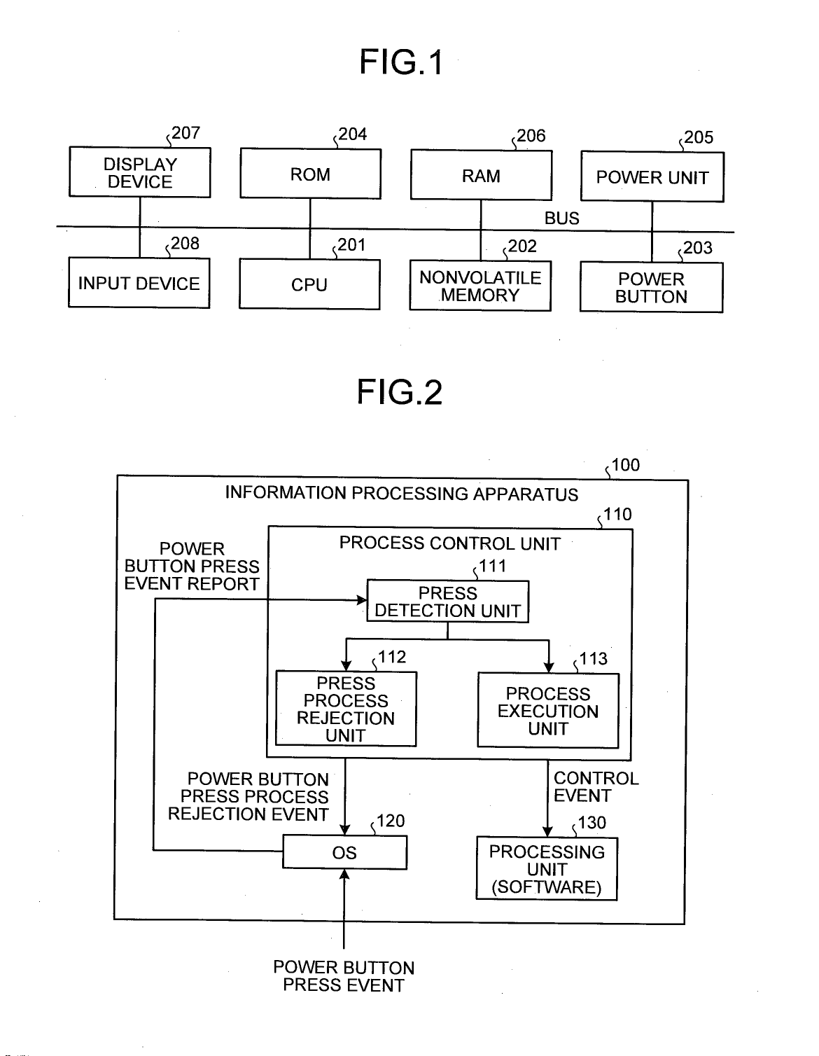

FIG. 1 is a hardware configuration view of an information processing apparatus 100 according to a first embodiment. As illustrated in FIG. 1, the information processing apparatus according to the present embodiment mainly includes a central processing unit (CPU) 201, a read only memory (ROM) 204, a random access memory (RAM) 206, a nonvolatile memory 202, a power unit 205, a power button 203, a display device 207 and an input device 208.

The display device 207 is, for example, a display apparatus and displays various screens ad information to the user. The input device 208 is, for example, a keyboard or mouse, and accepts an input of various kinds of information from the user.

The ROM 204 stores various programs. The CPU 201 executes the various programs stored in the ROM 204. The RAM 206 is used as an operation area at the time the CPU 201 executes the various programs. The nonvolatile memory 202 stores predetermined data.

The power unit 205 acquires an electric power from an external power or internal power and supplies power to each part of the information processing apparatus 100. The power button 203 is a hardware button that enables the user to press and, when being pressed by the user, turns on or off the power unit 205.

FIG. 2 is a block diagram illustrating a functional configuration of the information processing apparatus 100 according to the first embodiment. As illustrated in FIG. 2, the information processing apparatus 100 according to the present embodiment mainly includes an operating system (OS) 120 (hereinafter referred to as “OS 120”), a processing unit 130, and a process control unit 110.

According to the present embodiment, the information processing apparatus 100 is an embedded device in which the OS 120 and other programs are included in advance in the ROM 204. Also, the information processing apparatus 100 according to the present embodiment is a terminal for conference used in a teleconference system to conduct a teleconference with a remote place. However, this is just an example and it is arbitrary to use the information processing apparatus 100 according to the present embodiment for other intended purposes than the teleconference system. For example, it can be used for not only a normal computer but also a delivery apparatus and reception apparatus for video delivery, a transmission apparatus and reception apparatus for television broadcast, a car navigation apparatus, a game device, and so on.

Also, the information processing apparatus 100 according to the present embodiment is not limited to an embedded device and may employ a normal computer configuration to connect a hard disk drive apparatus (or HDD) or the like and execute an OS or various programs installed in the HDD.

Examples of the OS 120 include Windows (registered trademark) from Microsoft (registered trademark) but is not limited to this. In the OS 120, it is defined in advance to execute a power-off process as a predetermined press process in response to a press of the power button 203. However, in the present embodiment, in a case where the power button 203 is pressed, that is, in the case of detecting by reception of a power button press event that the power button 203 is pressed in a state where electrical power is supplied to the information processing apparatus 100, the OS 120 transmits a power button press event report, which indicates a report that the power button is pressed, to the process control unit 110 (i.e. press detection unit 111). Subsequently, when receiving the power button press process rejection event from the process control unit 110 (i.e. press process rejection unit 112), the OS 120 does not execute the power-off process.

The processing unit 130 is realized by predetermined software (i.e. program) executed by the CPU 201. In the present embodiment, when the power button is pressed in a case where the information processing apparatus 100 is powered on or in a state where electrical power is supplied to the information processing apparatus 100, the processing unit 130 receives a control event (described later) from the process control unit 110 (i.e. process execution unit 113) and executes a power-off inquiry process of displaying, on the display device 207, a dialogue box to send an inquiry to the user to inquire whether to turn the power off.

Further, in the dialogue box displayed by executing the above power-off inquiry process, when an instruction of power-off is given from the user, the processing unit 130 executes an end process.

As illustrated in FIG. 2, the process control unit 110 mainly includes the press detection unit 111, the press process rejection unit 112 and the process execution unit 113.

The press detection unit 111 detects a press of the power button 203 by the user, by receiving the power button press event report from the OS 120.

In a case where the press detection unit 111 detects a press of the power button 203, the press process rejection unit 112 transmits to the OS 120 a power button press process rejection event to instruct the rejection of execution of power-off process as a press process.

In a case where the press detection unit 111 detects a press of the power button 203, the process execution unit 113 transmits a control event to the processing unit 130. Here, the control event is a trigger to execute the power-off inquiry process and instructs execution of the power-off inquiry process.

Also, in a case where predetermined software is not activated and the processing unit 130 is not operated, the process execution unit 113 may be configured not to transmit the control event.

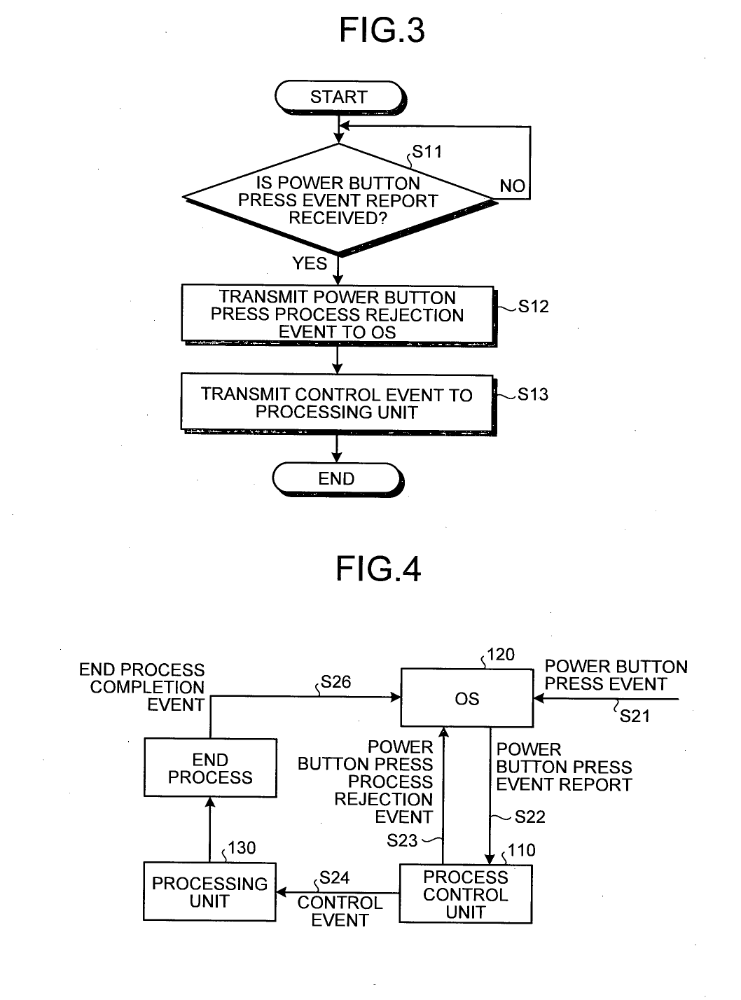

Next, an explanation will be given to control a process by the information processing apparatus 100 according to the present embodiment having the above configuration. FIG. 3 is a flowchart illustrating the steps of a control process according to the first embodiment. FIG. 4 is a view illustrating a flow of events between units according to the control process in the first embodiment.

The press detection unit 111 is in a reception waiting state of a power button press process event report from the OS 120, that is, in a detection waiting state of the press of the power button 203 (step S11). When receiving the power press event (step S21), the OS 120 transmits the power button press event report to the press detection unit 111 of the process control unit 110 (step S22).

Subsequently, in a case where the press detection unit 111 receives the power button press process event report from the OS 120 (step S11: Yes), the press process rejection unit 112 transmits a power button press process rejection event to the OS 120 (steps S12 and S23).

By this means, when receiving the power button press process rejection event, the OS 120 stops execution of the power-off process.

Next, the process execution unit 113 of the process control unit 110 transmits a control event to the processing unit 130 (steps S13 and S24). When receiving the control event, the processing unit 130 executes the power-off inquiry process and displays a power-off inquiry dialogue box on the display device 207.

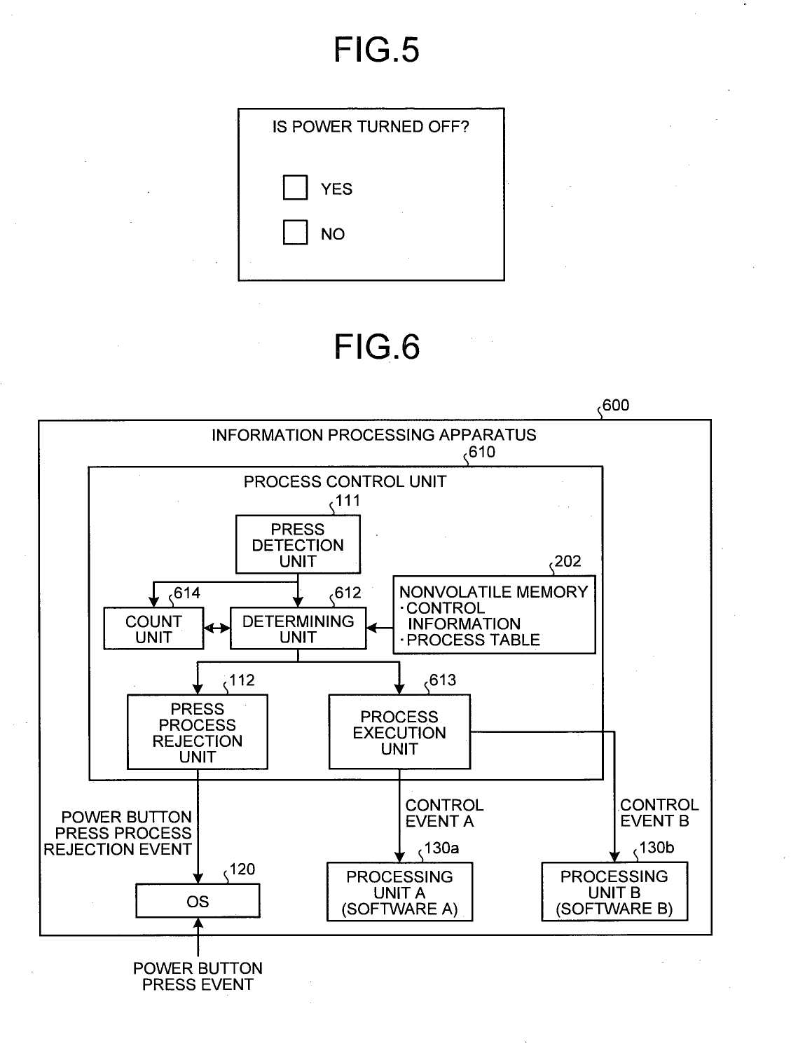

Here, FIG. 5 is a view illustrating an example of the power-off inquiry dialogue box. As illustrated in FIG. 5, the power-off inquiry dialogue box displays a message to inquire whether to turn the power off, and a checkbox in which it is possible to input user's response.

In this dialogue box, when the user inputs “No” indicating that the power is turned off, the processing unit 130 executes nothing and returns control to the OS 120. Meanwhile, in the dialogue box, when the user inputs “Yes” indicating that the power is turned off, the processing unit 130 executes an end process, and, after this end process is executed, transmits an end process completion event to the OS 120 (step S26). Subsequently, when receiving the end process completion event, the OS 120 executes the power-off process. By this means, it is possible to avoid a failure occurrence in the information processing apparatus 100 due to immediate power-off caused by pressing the power button 203 by the user, where the power-off is originally executed after completion of an essential end process.

Also, in the present embodiment, although the process execution unit 113 transmits a power button press process rejection event to the OS 120 and transmits a control event to the processing unit 130 in order, the process execution unit 113 may be configured so as to transmit the power button press process rejection event and the control event in parallel.

Thus, according to the present embodiment, in the case of detecting a press of the power button 203, the process control unit 110 transmits the power button press process rejection event to the OS 120 to cause the OS 120 to stop execution of the power-off process and transmits a control event to the processing unit 130 to cause it to make a power-off inquiry. Therefore, even when a power button is pressed by the user, it is possible to execute another process without immediately executing the power-off process assigned to the power button, which is convenient for the user.

### Second Embodiment

In the present embodiment, how many times the power button 203 is pressed is counted and a different process is executed according to the count.

FIG. 6 is a block diagram illustrating a functional configuration of an information processing apparatus 600 according to the second embodiment. Here, the hardware configuration of the information processing apparatus 600 according to the present embodiment is similar to that in the first embodiment explained using FIG. 1.

As illustrated in FIG. 6, the information processing apparatus 600 according to the present embodiment mainly includes a process control unit 610, the OS 120, a processing unit A (130a) and a processing unit B (130b). Here, the function of the OS 120 is similar to that in the first embodiment.

Also, the processing unit A receives a control event A and executes a predetermined process, and the processing unit B receives a control event B and executes a predetermined process. However, the process executed in the processing unit A and the process executed in the processing unit B are different from each other. Here, although the process in the processing unit A and the process in the processing unit B are arbitrary, for example, the power-off inquiry process as described in the first embodiment and an e-mail transmission process are given.

Also, in the present embodiment, although the information processing apparatus 600 includes two processing units of the processing unit A and the processing unit B, the number of processing units may be multiple and is not limited to two.

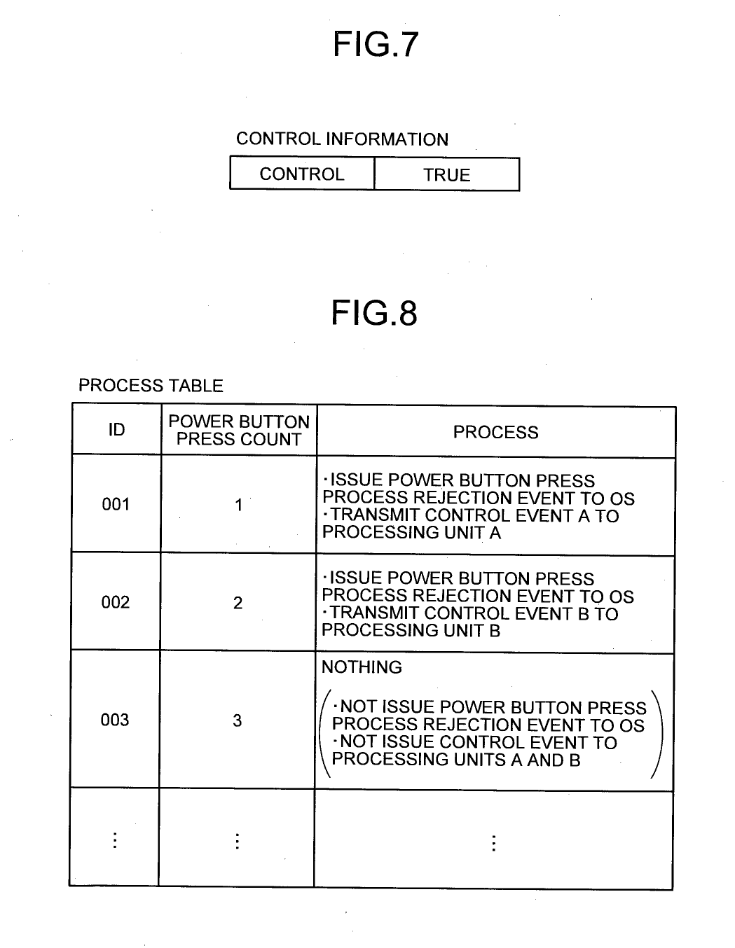

The nonvolatile memory 202 is as illustrated in FIG. 1, and, according to the present embodiment, stores control information and a process table. The control information denotes information indicating whether to execute another process without immediately executing the power-off-process in a case where the power button 203 is pressed. FIG. 7 is a view illustrating an example of the control information. As illustrated in FIG. 7, the control information has a Control flag, and, in a case where the Control flag is “true,” and the power button 203 is pressed, another process is executed without immediately executing the power-off process.

The process table denotes table data defining a process content according to the count of how many times the power button 203 is pressed (hereinafter, “press count”). FIG. 8 is a view illustrating an example of the process table. As illustrated in FIG. 8, in the process table, the press counts and processes based on the press counts are associated. As the process, it registers a content indicating whether to reject the execution of the power-off process as a press process and a content indicating whether to execute each process. To be more specific, whether to reject the execution of the power-off process indicates whether to transmit a power button press process rejection event to the OS 120, and whether to execute each process indicates which event is transmitted and to which processing unit the event is transmitted.

In the example in FIG. 8, it is set that, when the press count is one or two, the power button press process rejection event is transmitted to the OS 120, while, when the press count is three, nothing is executed, that is, the power button press process rejection event is not transmitted to the OS 120.

Also, in the example in FIG. 8, it is set that, when the press count is one, the control event A is transmitted to the processing unit A, and, when the press count is two, the control event B is transmitted to the processing unit B, while, when the press count is three, nothing is executed, that is, the control events are not transmitted to any of the processing units A and B.

As illustrated in FIG. 6, the process control unit 610 mainly includes a press detection unit 111, a count unit 614, a determining unit 612, the press process rejection unit 112 and a process execution unit 613. Here, the press detection unit 111 and the press process rejection unit 112 are similar to those in the first embodiment.

The count unit 614 counts the press count every time the press detection unit 111 detects the user's press of the power button 203, and counts the press count. Here, the count unit 614 processes only the press detected in a given amount of time as the count target.

By referring to the control information in the nonvolatile memory 202 and determining whether the Control flag is “true,” the determining unit 612 determines whether to execute another process without immediately executing the power-off process in a case where the power button 203 is pressed.

Also, based on the press count counted in the count unit 614, the determining unit 612 determines whether to execute the power-off process as a press process and whether to execute the predetermined process. To be more specific, the determining unit 612 refers to the process table in the nonvolatile memory 202, reads processing corresponding to the press count counted in the count unit 614, in the process table, and, according to the process content set in the process, determines whether to execute the power-off process and whether to execute the corresponding process in the processing unit A or the processing unit B. Further, the determining unit 612 gives an instruction to the press process rejection unit 112 and the process execution unit 613.

Regarding the process table, in the case of the example illustrated in FIG. 8, when the press count is one or two, the determining unit 612 instructs the press process rejection unit 112 to transmit the power button press process rejection event to the OS 120. When the press count is three, the determining unit 612 instructs the press process rejection unit 112 not to transmit the power button press process rejection event to the OS 120. That is, when the press count of the power button 203 is three, the power-off process is immediately executed without executing another process.

When the press count is one, the determining unit 612 instructs the process execution unit 613 to transmit the control event A to the processing unit A. When the press count is two, the determining unit 612 instructs the process execution unit 613 to transmit the control event B to the processing unit B. When the press count is three, the determining unit 612 instructs the process execution unit 613 not to transmit the control events to the processing units A and B.

According the determination instruction of the determining unit 612, the press process rejection unit 112 transmits or does not transmit the power button press process rejection event to the OS 120.

According to the determination instruction of the determining unit 612, the process execution unit 613 transmits the control event to the processing unit A or B to give an execution instruction, or does not transmit the control events to the processing units A and B not to give an execution instruction.

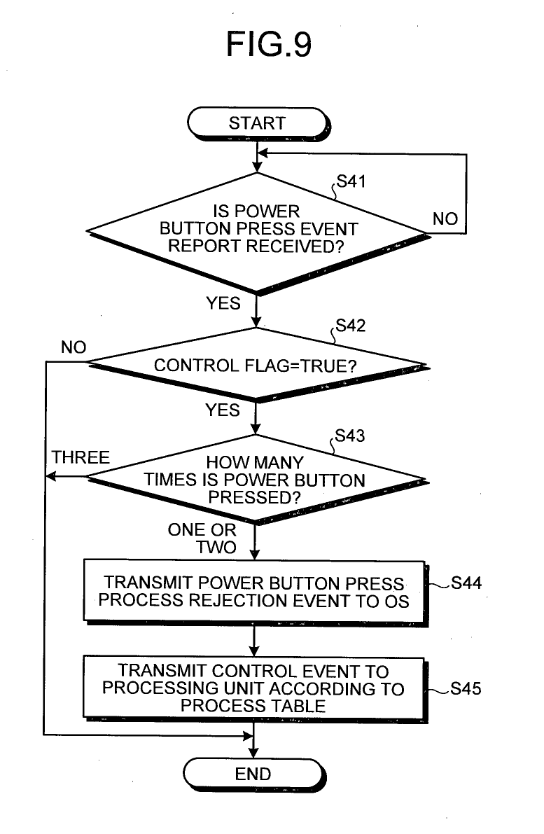

Next, a control process according to the present embodiment configured as above, will be explained. FIG. 9 is a flowchart illustrating the steps of the control process according to the second embodiment.

The press detection unit 111 is in a reception waiting state of a power button press process event report from the OS 120, that is, in a detection waiting state of a press of the power button 203 (step S41). Similar to the first embodiment, when receiving the power press event, the OS 120 transmits a power button press event report to the press detection unit 111. At this time, every time the press detection unit 111 receives the power button press event report and detects a press of the power button 203, the count unit 614 counts the press count.

In a case where the press detection unit 111 receives the power button press process event report from the OS 120 (step S41: Yes), the determining unit 612 refers to control information in the nonvolatile memory 202 and determines whether the Control flag is “true” (step S42).

Subsequently, in a case where the Control flag is not “true” (step S42: No), the process is finished. Therefore, in this case, it follows that, by pressing the power button 203, power-off is immediately executed by the OS 120.

Meanwhile, in a case where the Control flag is “true” (step S42: Yes), the determining unit 612 determines the press count counted in the count unit 614 (step S43). Subsequently, when the press count is three (step S43: three), since the process corresponding to the press count of three in the process table of the nonvolatile memory 202 is “nothing,” the process is finished without executing any process. Therefore, in this case, it follows that, by pressing the power button 203, power-off is immediately executed by the OS 120. In other words, if the user requests the power-off to be immediately executed, the power button 203 may be pressed three times continuously.

In step S43, in a case where the press count is one or two (step S43: one or two), since the process table of the nonvolatile memory 202 registers a content “transmit power button press process rejection event to OS” as the process corresponding to the press count of one and two, the determining unit 612 instructs the press process rejection unit 112 to transmit a power button press process rejection event, such that the press process rejection unit 112 transmits the power button press process rejection event to the OS 120 (step S44). By this means, when the OS 120 receives the power button press process rejection event, execution of the power-off process is stopped.

Next, according to the process corresponding to the press count of one or two in the process table, the determining unit 612 gives a control event transmission instruction to the process execution unit 613. By this means, the process execution unit 613 transits the control event A to the processing unit A and transmits the control event B to the processing unit B (step S45).

Thus, depending on a request to execute processing by the processing unit A or a request to execute processing by the processing unit B, the user can select whether to press the power button 203 once or press the power button 203 twice continuously.

According to the present embodiment, since the press count of the power button 203 is counted and rejection of the power-off process and the respective processes in the processing units A and B are executed based on the press count, in addition to the effect of the first embodiment, it is possible to select execution of a user's desired process and turn the power off based on the press count of the power button 203, which is more convenient for the user.

Also, the control programs executed in the information processing apparatuses 100 and 600 according to the first and second embodiments are preprogrammed in the ROM 204 or the like and provided.

The control programs executed in the information processing apparatuses 100 and 600 according to the first and second embodiments may be recorded and provided, as files in an installable format or executable format, in a computer-readable recording medium such as a CD-ROM, flexible disk (FD), CD-R and Digital Versatile Disk (DVD).

Further, the control programs executed in the information processing apparatuses 100 and 600 according to the first and second embodiments may be stored in a computer connected to a network such as the Internet, so as to be provided by download via the network. Also, the control programs executed in the information processing apparatuses 100 and 600 according to the first and second embodiments may be provided or distributed via a network such as the Internet.

The control programs executed in the information processing apparatuses 100 and 600 according to the first and second embodiments has a module configuration including the above units (i.e. the press detection unit 111, the press process rejection unit 112, the process execution units 113 and 613, the count unit 614 and the determining unit 612), and, as actual hardware, when the CPU (processor) reads a control program form the above ROM and executes it, the above units are loaded on a main storage apparatus such that the press detection unit 111, the press process rejection unit 112, the process execution units 113 and 613, the count unit 614 and the determining unit 612 are produced on the main storage apparatus.

According to the embodiments, there is an advantage that, even when a specific hardware button is pressed, it is possible to execute another process without executing the process corresponding to the hardware button, which is convenient for the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An information processing apparatus comprising:
a hardware button configured to enable a user to press;
a control unit configured to define a predetermined press process executed in response to a press of the hardware button;
a processing unit configured to execute a predetermined process;
a press detection unit configured to detect the press of the hardware button;
a press process rejection unit configured to instruct the control unit to reject the execution of the press process when the press of the hardware button is detected; and
a process execution unit configured to instruct the processing unit to execute the predetermined process when the press of the hardware button is detected.

2. The information processing apparatus according to claim 1, wherein
the hardware button is a power button,
the control unit defines a power-off process executed as the press process, and
the press process rejection unit instructs the control unit to reject the execution of the power-off process when the press of the power button is detected.

3. The information processing apparatus according to claim 2, wherein
the processing unit executes a power-off inquiry process as the predetermined process, and
the process execution unit instructs the processing unit to execute the power-off inquiry process when the press of the power button is detected.

4. The information processing apparatus according to claim 3, wherein the processing unit further executes end processing when receiving an instruction of power-off from the user in the inquiry process.

5. The information processing apparatus according to claim 1, further comprising:
a count unit configured to count how many times the hardware button is pressed every time the press detection unit detects the press of the hardware button; and
a determining unit configured to determine whether to reject the execution of the press process and whether to execute the predetermined process, based on the count of how many times the hardware button is pressed, wherein
the press process rejection unit instructs the control unit to reject the execution of the press process based on the determination by the determining unit, and
the process execution unit instructs the processing unit to execute the predetermined process based on the determination made by the determining unit.

6. The information processing apparatus according to claim 5, wherein
the processing unit executes multiple processes different from each other,
the determining unit determines whether to reject the execution of the press process and whether to execute each of the processes, based on the count of how many times the hardware button is pressed, and
the process execution unit instructs the processing unit to execute each of the processes based on the determination made by the determining unit.

7. The information processing apparatus according to claim 6, further comprising a storage unit configured to store process information in which a count of how many times the hardware button is pressed, information as to whether to reject the execution of the press process, and information as to whether to execute each of the processes are associated with each other, wherein
the determining unit determines whether to reject the execution of the press process and whether to execute each of the processes which are associated with the count of how many times the hardware button is pressed counted by the count unit in the process information,
the press process rejection unit instructs the control unit to reject the rejection of the press process according to the determination made by the determining unit, and
the process execution unit instructs the processing unit to execute each of the processes according to the determination made by the determining unit.

8. The information processing apparatus according to claim 7, wherein
the hardware button is a power button,
the control unit executes a power-off process as the press process,
the count unit counts how many times the power button is pressed every time the press detection unit detects the press of the power button,
the process information associates a count of how many times the power button is pressed, information as to whether to reject the execution of the power-off process, and information as to whether to execute each of the processes,
the determining unit determines whether to reject the execution of the power-off process and whether to execute each of the processes which are associated with the count of how many times the power button is pressed counted by the count unit in the process information, and
the press process rejection unit instructs the control unit to reject the execution of the power-off process according to the determination made by the determining unit.

9. The information processing apparatus according to claim 1, wherein the control unit is an operating system.

10. A control method executed in an information processing apparatus including a hardware button configured to enable a user to press, the method comprising:
executing a predetermined process by a processing unit;
detecting the press of the hardware button by a press detection unit;
instructing, by a press process rejection unit, a control unit to reject the execution of a predetermined press process when the press of the hardware button is detected, the control unit defining the press process executed in response to a press of the hardware button; and
instructing, by a process execution unit, the processing unit to execute the predetermined process when the press of the hardware button is detected.

11. A non-transitory computer-readable recording medium with an executable program stored thereon, wherein the program instructs a computer that includes a hardware button configured to enable a user to press, to perform:
executing a predetermined process;
detecting the press of the hardware button;
instructing a control unit to reject the execution of a predetermined press process when the press of the hardware button is detected, the control unit defining the press process executed in response to a press of the hardware button; and
instructing the execution of the predetermined process when the press of the hardware button is detected.
